(19) United States
(12) Patent Application Publication
(10) Pub. No.: US 2006/0034674 A1
(43) Pub. Date: Feb. 16, 2006

(54) Drop deck bed design for vehicle recovery systems

(76) Inventor: Ronald B. Nespor, Greenville, PA (US)

Correspondence Address: MICHAEL P. MAZZA, LLC, 686 CRESCENT BLVD., GLEN ELYN, IL, 60137, US

(21) Appl. No.: 10/916,104

(22) Filed: Aug. 11, 2004

(51) Int. Cl. B60P 1/04

(52) U.S. Cl. 414/480

(57) ABSTRACT

A bed platform used with a towing vehicle, such as a car carrier, for recovering a vehicle. The bed platform includes an approach plate inclined at an approach angle, a deck having a dropped deck surface and inclined at a drop deck angle, and an offset surface connecting the approach and drop deck surfaces. The offset surface forms an offset angle which is substantially different from the approach and drop deck angles, thus providing additional clearance for the bottom front portion of the vehicle to be loaded onto the bed platform as it moves from the approach to the drop deck surfaces. A method for using such a bed platform is also claimed.

### BACKGROUND OF THE INVENTION

The present invention relates to the field of vehicle carriers. More specifically, this invention relates to the field of bed platform designs for loading, carrying and transporting vehicles, especially low-clearance vehicles, on vehicle carriers.

It is well known in the art to load vehicles, such as new or disabled vehicles, onto the bed platforms of vehicle recovery systems such as car carriers. One such car carrier, a combination tilting bed vehicle carrier and attached wheel lift, is disclosed in U.S. Pat. No. 5,061,147 by the present inventor, and is hereby incorporated by reference in its entirety.

The prior art discloses various ways of designing vehicle carriers and particularly systems for loading vehicles onto vehicle carriers. One prior art design teaches flat bed platforms pivotally connected to the chassis and capable of tilting and extending back from the chassis toward the vehicle to be loaded at a loading angle in the range of 13 degrees. Once the vehicle is loaded onto the tilted, extended bed platform, the bed platform then returns to its original position on the chassis. This design has many moving parts and can include two separate platforms at different angles.

Another prior art design discloses a dual angle deck which forms a rigid, flattened V-shape.

Dual angle beds suffer from several problems. First, as the recovered vehicle is being winched onto a dual angle bed it may clear the initial incline, but it may not clear the second incline. Because the approach angle for the first incline is above horizontal, the second incline is also pivoted over a greater angle range than conventional, straight beds, causing the second inclined portion to be tilted at a greater angle, which may result in damage to (e.g.) the typically plastic air dams on the front, lower portion of winched vehicles.

Second, as just explained, in order for the dual angle bed to achieve a low angle at the vehicle approach, the front (second) portion of the dual angle bed will be at a higher angle than the bed of a traditional carrier. This higher angle of the front bed portion will cause the winch to be positioned higher above the ground, causing the cable to attach to the towed vehicle at a steep angle. The solution to this steep cable angle problem is to insert a removable pulley near the pivotal connection between the front bed portion and the approach portion, for temporarily rerouting the cable, as shown in FIG. 1.

These prior art designs often require additional time and expense, and may result in damage to the front of the recovered vehicles. Damage can occur in several ways, including scraping the front end of the recovered vehicle on the bed platform's surface as the vehicle is loaded onto the tilted bed platform. The winch cable pulling or securing the recovered vehicle in position on the bed platform can also damage the front end of the recovered vehicle. The winch cable is preferably located adjacent the surface of the bed platform, as it is not desirable to have the tensioned cable scrape against and possibly damage air dams of winched vehicles. The prior art designs described above, such as shown in FIG. 1, can increase this tendency.

Past bed designs have attempted to solve these problems by minimizing the angle between the ground and the vehicle carrier, but such attempts have not proven satisfactory.

Accordingly, a principal object of the present invention is the provision of a drop deck design for use with vehicle recovery systems having a bed platform, which provides additional clearance for recovered vehicles while solving the problems associated with dual angle decks.

### SUMMARY OF THE INVENTION

The objects mentioned above, as well as other objects which will be apparent on reading this disclosure to those of ordinary skill in the art, are achieved by the present invention, which overcomes disadvantages of prior vehicle recovery systems and assemblies, while providing new advantages not previously obtainable with such systems and assemblies.

The present invention provides a bed platform design for use with towing vehicles and/or vehicle carriers which generally minimizes the risk of damaging vehicles as they are loaded onto the towing vehicle or vehicle carrier. This is accomplished by providing a bed platform design having an offset surface at an angle substantially different from the approach and deck angles. During loading, damage may be minimized by generally offsetting the drop deck surface lower than the approach plate.

In the preferred embodiment, a recovery vehicle having a bed platform mounting a vehicle to be loaded on the bed platform is provided. The bed platform, which may consist of a generally straight, rigid deck, includes an approach plate facilitating movement of the disabled vehicle onto the bed platform. The approach plate has a work surface defining an approach surface and is inclined at an approach angle during vehicle loading. The bed platform also includes a deck for supporting the disabled vehicle. The deck has a dropped, work surface offset from the approach surface. defining a drop deck surface. The drop deck surface is inclined at a load angle during vehicle loading. The bed platform further includes an offset surface connecting the approach surface to the drop deck surface. The offset surface defines, during vehicle loading, an offset angle which is substantially different than the approach and drop deck angles, and which provides additional clearance for the bottom front portion of the loaded vehicle as it moves from the approach surface to the drop deck surface.

In one preferred embodiment, the offset surface may be generally parallel to the ground. In another embodiment, if the drop deck surface is positioned parallel to the ground, and the drop deck and approach plate surfaces are parallel, the drop deck surface is approximately two inches closer to the ground than the approach plate.

A winch cable may be used to attach the vehicle to be loaded onto the bed platform to a loading mechanism. Preferably, due to the preferred bed platform design, the winch cable may be positioned substantially parallel to the drop deck surface, such that the winch cable is in close proximity (e.g., three inches or less) to and/or above the drop deck surface. The winch cable may be directly connected between the loading mechanism and the disabled vehicle.

In a preferred embodiment, the offset surface of the bed platform relative to the approach surface forms an angle in the range of between about 9-13 degrees, while the drop deck angle is in the range of between about 10-15 degrees. In a preferred embodiment, the offset angle is in the range of between about 1-2 degrees.

In an alternative, yet preferred, embodiment, a method is provided for using a recovery vehicle having a bed platform and mounting a vehicle to be loaded on the bed platform. In this preferred method, a vehicle to be loaded may be initially moved onto the bed platform over an approach plate which forms a distal end of the bed platform. The approach plate may have a work surface defining an approach surface and may be inclined at an approach angle. The bed platform may also have a work surface defining a dropped deck surface which forms the main portion of the bed platform and is inclined at a drop deck angle. The bed platform may also have an offset portion having a work surface defining an offset surface which is located intermediate between the approach and dropped deck surfaces and which is inclined at an offset angle. Once the vehicle to be loaded is moved over the offset surface onto the bed platform, the offset angle may be substantially different from the approach and drop deck angles. Now, the vehicle is continued to be moved, such as by winching, over the offset surface and onto the dropped deck surface until the vehicle is entirely supported on the dropped deck surface and is in a fixed position on the dropped deck surface. During movement of the vehicle to be loaded, additional clearance may be provided for the bottom front portion of the vehicle as it moves from the approach surface to the drop deck surface due to the presence of the offset surface and the offset angle. The bed platform used may include a straight, rigid platform which is not pivotable at intermediate locations along its length.

### BRIEF DESCRIPTION OF THE DRAWINGS

The novel features which are characteristic of the invention are set forth in the appended claims. The invention itself, however, together with further objects and attendant advantages thereof, will best be understood by reference to the following description taken in connection with the accompanying drawings, in which:

FIG. 1 is a side view of a car carrier using a prior art, dual-angle deck;

FIG. 2 is a planar and side perspective view of the bed design of the present invention;

FIG. 3 is a side view of a vehicle just prior to mounting a preferred embodiment of the drop deck bed of the present invention;

FIG. 4 is a partial side view showing a vehicle to be loaded at approach to the drop deck bed design according to the present invention;

FIG. 5 is a view similar to FIG. 4 illustrating the vehicle position with its front tires mounted on the approach plate; and

FIG. 6 is a view similar to FIG. 4 illustrating the vehicle position with its front tires passing from the offset surface to the inclined bed surface.

### DEFINITION OF THE CLAIM TERMS

The terms used in the claims of the patent as filed are intended to have their broadest meaning consistent with the requirements of law.

“Drop deck angle,” “approach angle” and “offset angle” all define an angle between the recited work surface and the ground.

“Work surface” refers to the surface contacted by the vehicle to be loaded onto the bed platform.

Where alternative meanings are possible, the broadest meaning is intended. All words used in the claims are intended to be used in the normal, customary usage of grammar and the English language.

### DETAILED DESCRIPTION OF THE PREFERRED EMBODIMENTS

Set forth below is a description of what are believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

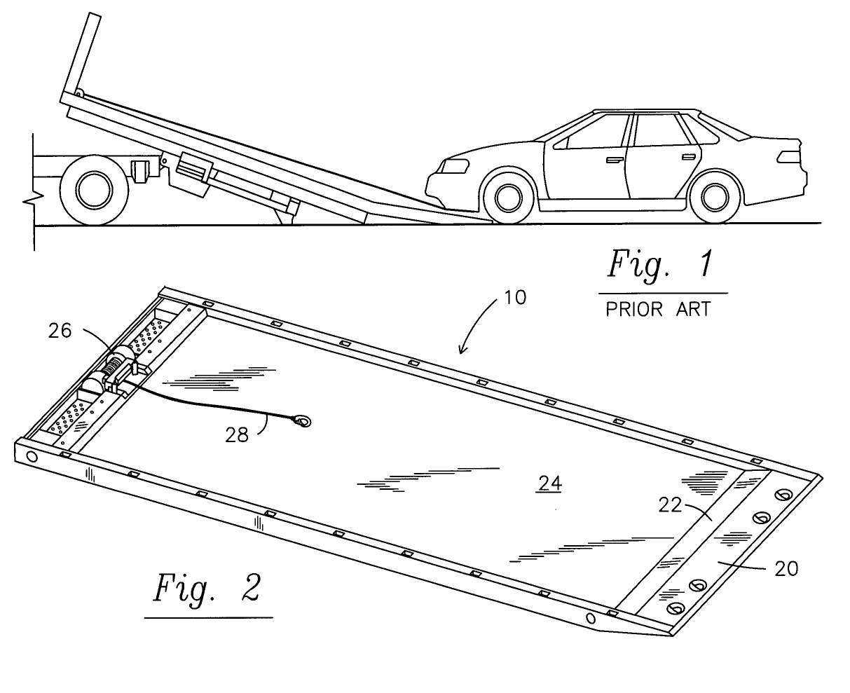

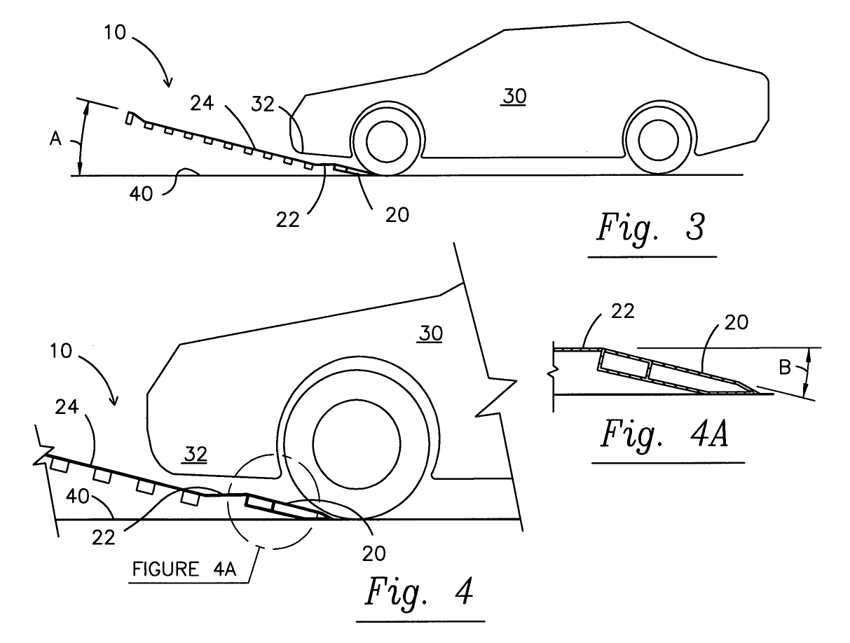

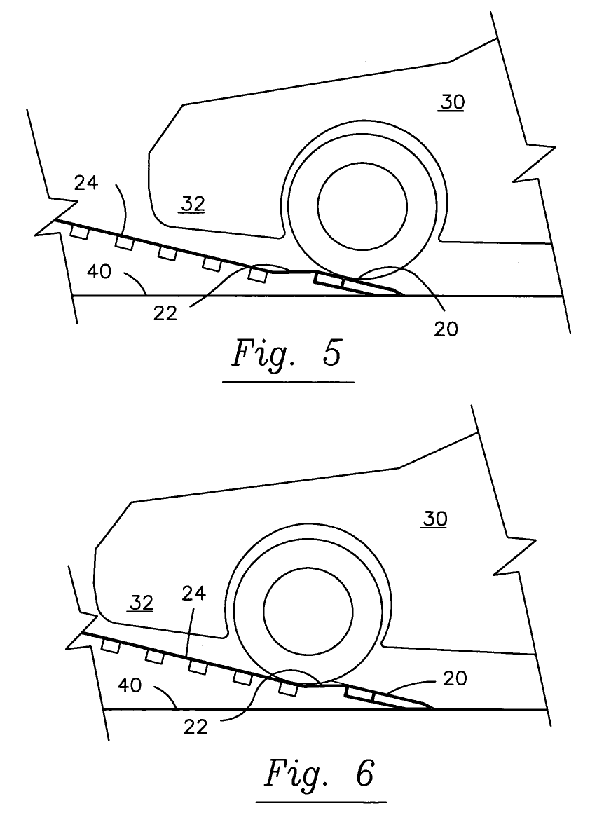

In accordance with a preferred embodiment of this invention, a drop deck bed design 10 is shown in FIGS. 1-3. Drop deck bed design 10 includes an approach plate 20 which contacts the ground 40 when the deck is extended and tilted in the loading position, as described in U.S. Pat. No. 5,061,147 to Nespor. In the preferred embodiment, and referring now to FIG. 3, the approach plate 20 may form an angle “A” with the ground 40 generally at 13 degrees, for example, as shown in FIG. 3, although other angles, such as in the range of between about 10-15 degrees, are acceptable. Rather than a level bed, drop deck bed design 10 includes an offset portion 22 between the approach plate 20 and the drop deck floor surface 24. Offset surface 22 may be generally parallel to the ground 40 when the bed is in an inclined, loading position. In a preferred embodiment, for example, deck floor surface 24 may lie about 2 inches below approach plate 20, although this distance may be adjusted for different applications.

The deck floor surface 24 may be generally parallel to the approach plate 20. The offset in the drop deck bed design may generally allow a vehicle 30 to be loaded on the deck floor surface 24 for transport without damaging the lower front end 32 of the vehicle 30 by generally adding 2 inches, for example, of clearance for the front end 32 during the loading process. The lower drop deck surface generally causes the approach plate to function like ramp blocks behind a traditional bed.

Referring to FIG. 2, the drop deck bed design 10 may include a winch 26 at the end opposite from the approach plate 20. Winch 26 has a cable 28 which may be used to pull vehicle 30 onto the bed, as described in the Nespor '147 patent and as generally known in the art. Drop deck bed design 10 allows cable 28 to remain close to deck floor surface 24 (e.g., within about 2-3 inches) during the loading process so that cable 28 does not damage the front end 32 of vehicle 30 as it is loaded onto deck floor surface 24.

A straight deck bed platform design is preferred, since in conjunction with the present invention this allows the winch cable to remain in preferred, close proximity to the platform floor to prevent possible damage to recovered vehicles by contact with the tensioned cable during their winching onto the bed platform.

In a preferred embodiment of the invention, and referring now to FIGS. 4 and 4A, offset surface 22 may form an angle “B” of between about 9-13 degrees with approach surface 20. In this way, if bed surface 24 is inclined at 13 degrees to ground (i.e., A in FIG. 3 is 13 degrees), and offset surface 22 relative to approach surface 20 is also 13 degrees (i.e., B in FIG. 4A is 13 degrees), then offset surface 22 will be parallel to the ground. In another situation, if bed surface 24 is inclined at 13 degrees to ground (A is 13 degrees) and offset surface 22 relative to approach surface 20 is 12 degrees (B is 12 degrees), then the offset surface is inclined 1 degree relative to the ground. Similarly, if A is 13 degrees, and B is 9 degrees, then offset surface 22 will be inclined 4 degrees relative to the ground. As a final example, if A is 10 degrees and B is 9 degrees, then offset surface 22 will be inclined 1 degree relative to the ground. In a particularly preferred embodiment, offset surface 22 is inclined between about 1-2 degrees relative to ground so that a vehicle can roll off the bed completely without assistance.

Other changes and modifications constituting insubstantial differences from the present invention, such as those expressed here or others left unexpressed but apparent to those of ordinary skill in the art, can be made without departing from the spirit and scope of the present invention and without diminishing its attendant advantages. It is, therefore, intended that such changes and modifications be covered by the following claims.

I claim:

1. A recovery vehicle having a bed platform mounting a vehicle to be loaded on the bed platform, the bed platform comprising:
an approach plate facilitating movement of the disabled vehicle onto the bed platform, the approach plate having a work surface defining an approach surface and inclined at an approach angle during vehicle loading;
a deck for supporting the disabled vehicle, the deck have a dropped, work surface offset from the approach surface and defining a drop deck surface, the drop deck surface being inclined at a load angle during vehicle loading;
an offset surface connecting the approach surface to the drop deck surface, the offset surface defining, during vehicle loading, an offset angle which is substantially different than the approach and drop deck angles, and which provides additional clearance for the bottom front portion of the loaded vehicle as it moves from the approach surface to the drop deck surface.

2. The bed platform of claim 1, wherein the offset surface is generally parallel to the ground.

3. The bed platform of claim 1 wherein, if the drop deck surface is positioned parallel to the ground, and the drop deck and approach plate surfaces are parallel, the drop deck surface is approximately two inches closer to the ground than the approach plate.

4. The bed platform of claim 1, further comprising a winch cable connecting the vehicle to be loaded onto the bed platform to a loading mechanism, the winch cable being substantially parallel to the drop deck surface.

5. The bed platform of claim 4, wherein the winch cable is in close proximity to the drop deck surface.

6. The bed platform of claim 5, wherein the winch cable is located about three inches or less above the drop deck surface.

7. The bed platform of claim 4, wherein the winch cable is directly connected between the loading mechanism and the disabled vehicle.

8. The bed platform of claim 1, wherein the offset surface relative to the approach surface forms an angle in the range of between about 9-13 degrees.

9. The bed platform of claim 1, wherein the drop deck angle is in the range of between about 10-15 degrees.

10. The bed platform of claim 1, wherein the offset angle is in the range of between about 1-2 degrees.

11. The bed platform of claim 1, wherein the bed platform comprises a straight, rigid deck.

12. A method using a recovery vehicle having a bed platform mounting a vehicle to be loaded on the bed platform, comprising the steps of:
initially moving the vehicle to be loaded onto the bed platform over an approach plate which forms a distal end of the bed platform, the approach plate having a work surface defining an approach surface and inclined at an approach angle, the bed platform also having a work surface defining a dropped deck surface which forms the main portion of the bed platform and is inclined at a drop deck angle, and an offset portion having a work surface defining an offset surface which is located intermediate between the approach and dropped deck surfaces and which is inclined at an offset angle;
moving the vehicle to be loaded over the offset surface, the offset angle being substantially different from the approach and drop deck angles;
continuing to move the vehicle over the offset surface and onto the dropped deck surface until the vehicle is entirely supported on the dropped deck surface and is in a fixed position on the dropped deck surface;
wherein during movement of the vehicle to be loaded, additional clearance is provided for the bottom front portion of the vehicle as it moves from the approach surface to the drop deck surface due to the presence of the offset surface and the offset angle.

13. The method of claim 12, wherein the bed platform comprises a straight, rigid platform which is not pivotable at intermediate locations along its length.
